(19) United States
(12) Patent Application Publication
(10) Pub. No.: US 2019/0301665 A1
(43) Pub. Date: Oct. 3, 2019

(54) LOCK RACK FOR PORTABLE ELECTRONIC DEVICES

(71) Applicant: Sinox Co., LTD., New Taipei City (TW)

(72) Inventor: Jia-Qi Wu, New Taipei City (TW)

(21) Appl. No.: 16/299,475

(22) Filed: Mar. 12, 2019

(30) Foreign Application Priority Data
Mar. 30, 2018 (TW) TW 107204146

(51) Int. Cl. F16M 11/12; E05B 73/00; F16M 13/02

(52) U.S. Cl. CPC F16M 11/12; F16M 13/02; E05B 73/0082

(57) ABSTRACT

A lock rack contains: a case, a support mounting, and a movable press rod. The case includes a locking orifice. The support mounting includes a first extending fixer and a second extending fixer which are rotatably connected with the case and are meshed with each other, the first extending fixer has a first engagement portion for engaging with a first corner of a lower end of the portable electronic device, and a second extending fixer has a second engagement portion for engaging with a second corner of the lower end of the portable electronic device. The movable press rod is inserted into the case and includes a retainer configured to retain with an upper end of the portable electronic device.

### FIELD OF THE INVENTION

The present invention relates to a lock rack which is applicable for a variety of portable electronic devices having different sizes.

### BACKGROUND OF THE INVENTION

Portable electronic device (such as a tablet and a smartphone) is expensive, so it is important to avoid the portable electronic device being stolen. However, the many electronic devices cannot be locked securely.

The present invention has arisen to mitigate and/or obviate the afore-described disadvantages.

### SUMMARY OF THE INVENTION

The primary aspect of the present invention is to provide a lock rack which is applicable for a variety of portable electronic devices having different sizes.

To obtain above-mentioned aspect, a lock rack provided by the present invention contains: a case, a support mounting, and a movable press rod.

The case includes a locking orifice.

The support mounting includes a first extending fixer and a second extending fixer which are rotatably connected with the case and are meshed with each other, the first extending fixer has a first engagement portion for engaging with a first corner of a lower end of the portable electronic device, and a second extending fixer has a second engagement portion for engaging with a second corner of the lower end of the portable electronic device.

The movable press rod is inserted into the case and includes a retainer configured to retain with an upper end of the portable electronic device.

Preferably, a protective pad made of flexible material is attached on the case, the first extending fixer, the second extending fixer, and the movable press rod. The protective pad contacts the portable electronic device's surface.

Preferably, the first extending fixer has a first gear portion, and the second extending fixer has a second gear portion meshing with the first gear portion.

Preferably, the first extending fixer is movable and has a first push button configured to fix a moving length of the first extending fixer, the second extending fixer is movable and has a second push button configured to fix a moving length of the second extending fixer, the first extending fixer further has a first resilient element configured to position the first push button, and the second extending fixer further has a second resilient element configured to position the second push button.

Preferably, the lock rack further contains:

a flexible stop plate arranged on the case and configured to limit a movement of the movable press rod;

a movable drive block mounted on the case and including a fixing aperture, wherein the movable drive block is movable toward a first position on which the fixing aperture corresponds to the locking orifice, and the movable drive block is movable toward a second position on which the flexible stop plate releases the movable press rod.

Preferably, the movable press rod further includes multiple recesses configured to retain with the flexible stop plate.

Preferably, the movable drive block is pushed by one or multiple springs to position at the first position.

Preferably, the lock rack further contains: a bracket connected with the case.

Preferably, the case includes at least one connection orifice configured to connect with the bracket.

Preferably, the bracket includes a universal joint coupled with one of the at least one connection orifice.

### BRIEF DESCRIPTION OF THE DRAWINGS

FIG. 1 is a perspective view showing the application of a lock rack according to a preferred embodiment of the present invention.

FIG. 2 is another perspective view showing the application of the lock rack according to the preferred embodiment of the present invention.

FIG. 3 is a perspective view showing the assembly of the lock rack according to the preferred embodiment of the present invention.

FIG. 4 is another perspective view showing the assembly of the lock rack according to the preferred embodiment of the present invention.

FIG. 5 is a perspective view showing the exploded components of the lock rack according to the preferred embodiment of the present invention.

FIG. 6 is a side plan view showing the assembly of a part of the lock rack according to the preferred embodiment of the present invention.

FIG. 7 is a side plan view showing the operation of a part of the lock rack according to the preferred embodiment of the present invention.

FIG. 8A is another side plan view showing the operation of a part of the lock rack according to the preferred embodiment of the present invention.

FIG. 8B is a cross-sectional view showing the operation of a part of the lock rack according to the preferred embodiment of the present invention.

FIG. 9A is also another side plan view showing the operation of a part of the lock rack according to the preferred embodiment of the present invention.

FIG. 9B is another cross-sectional view showing the operation of a part of the lock rack according to the preferred embodiment of the present invention.

FIG. 10A is a side plan view showing the application of a part of the lock rack according to the preferred embodiment of the present invention.

FIG. 10B is another side plan view showing the application of a part of the lock rack according to the preferred embodiment of the present invention.

### DETAILED DESCRIPTION OF THE PREFERRED EMBODIMENTS

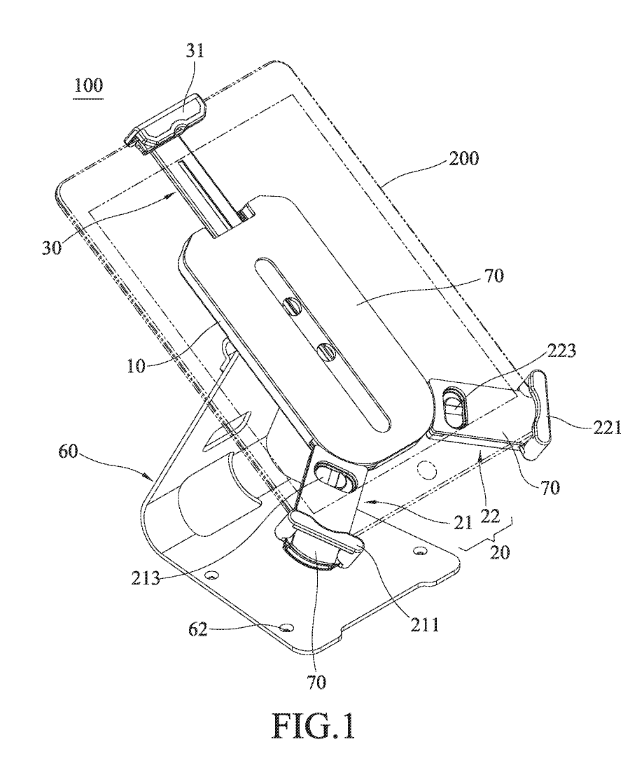

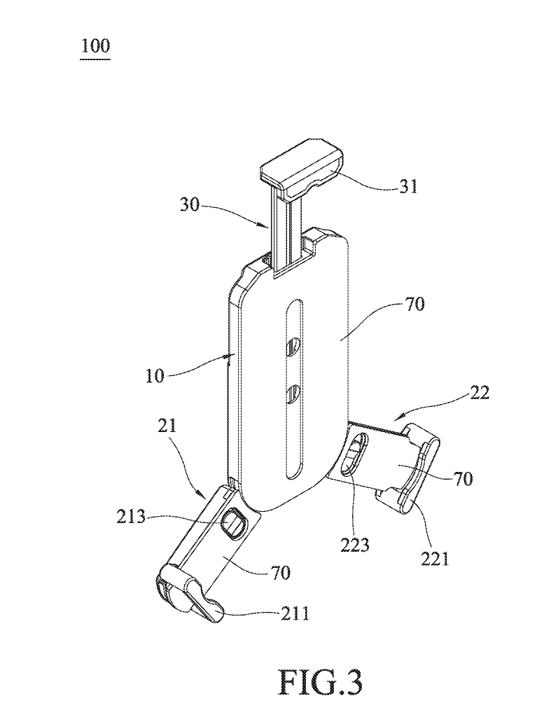

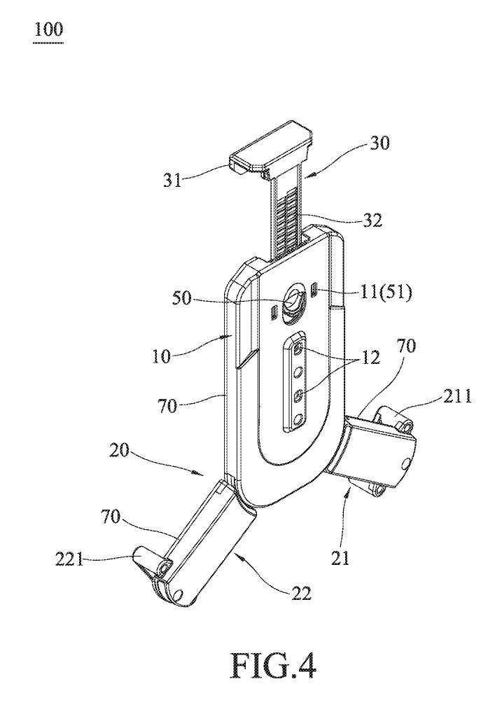

With reference to FIGS. 1-5, a lock rack 100 for portable electronic devices (such as a tablet and a smartphone) according to a first embodiment of the present invention comprises: a case 10 including a locking orifice 11, a support mounting 20 configured to hold the tablet 200, and a movable press rod 30.

The support mounting 20 includes a first extending fixer 21 and a second extending fixer 22 which are rotatably connected with the case 10 and are meshed with each other, the first extending fixer 21 has a first engagement portion 211 for engaging with a first corner of a lower end of the portable electronic device 200, and a second extending fixer 22 has a second engagement portion 221 for engaging with a second corner of the lower end of the portable electronic device 200.

The portable electronic device 200 is in a rectangle shape or a polygon shape, and the first and second corners of the lower end of the portable electronic device 100 can be round corners, arcuate or any other shapes.

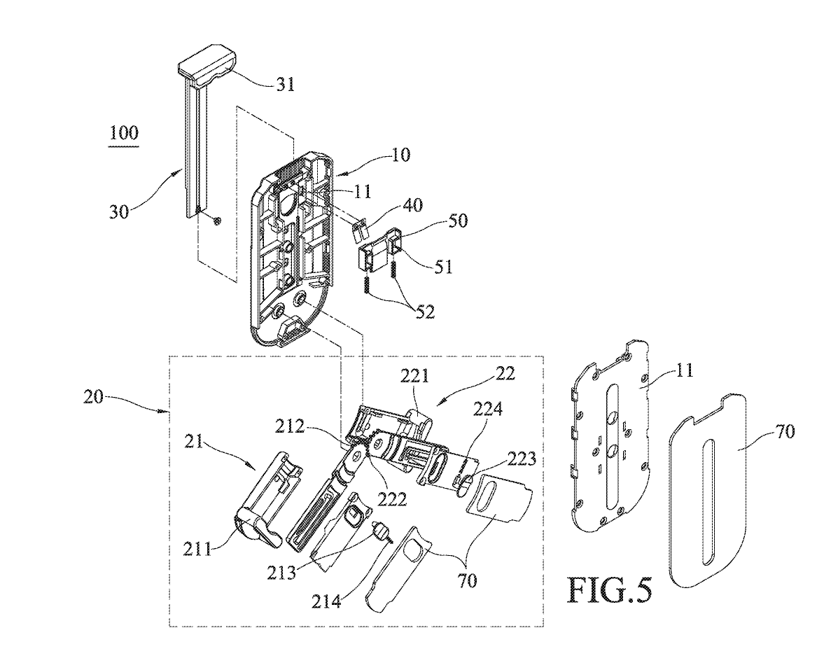

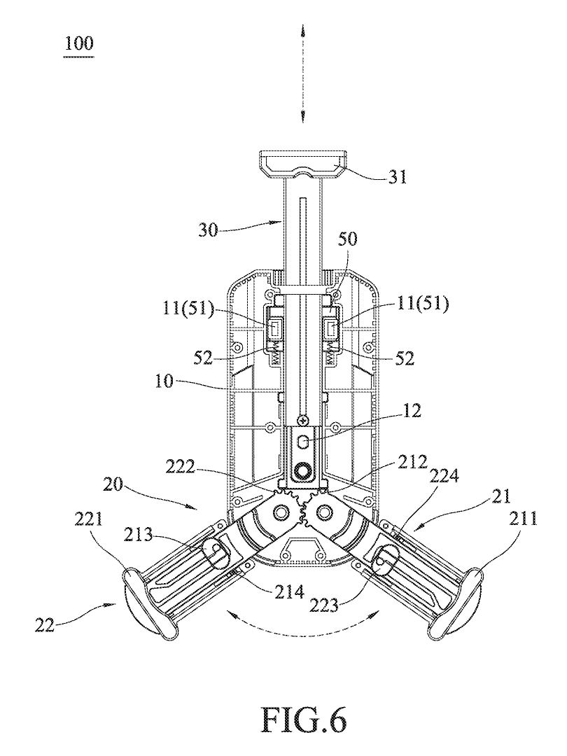

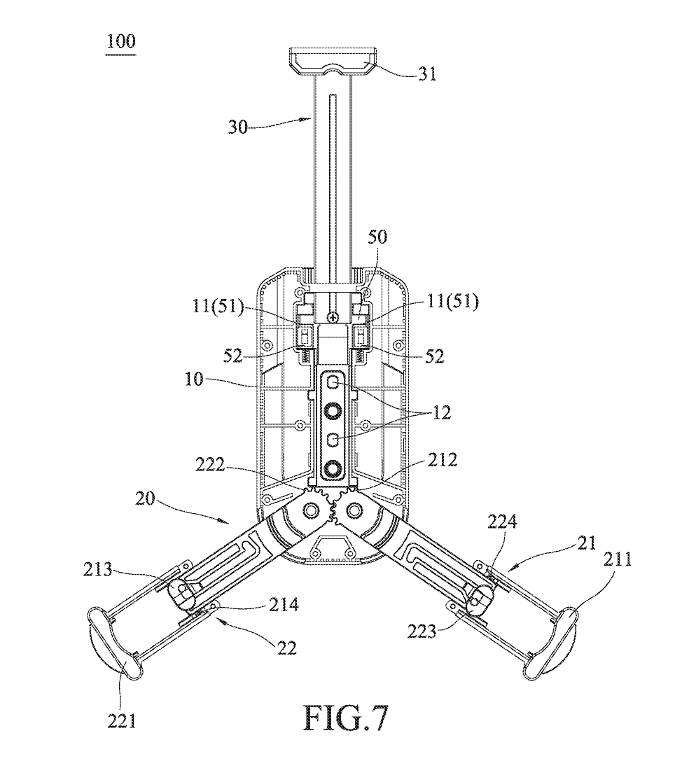

Referring to FIGS. 5, 6, and 7, the first extending fixer 21 has a first gear portion 212, and the second extending fixer 22 has a second gear portion 222 meshing with the first gear portion 212. The first extending fixer 21 is movable and has a first push button 213 configured to fix a moving length of the first extending fixer 21. The second extending fixer 22 is movable and has a second push button 223 configured to fix a moving length of the second extending fixer 22. The first extending fixer 21 further has a first resilient element 214 configured to position the first push button 213, and the second extending fixer 22 further has a second resilient element 224 configured to position the second push button 223.

The movable press rod 30 is inserted into the case 10 and includes a retainer 31 configured to retain with an upper end of the portable electronic device 200.

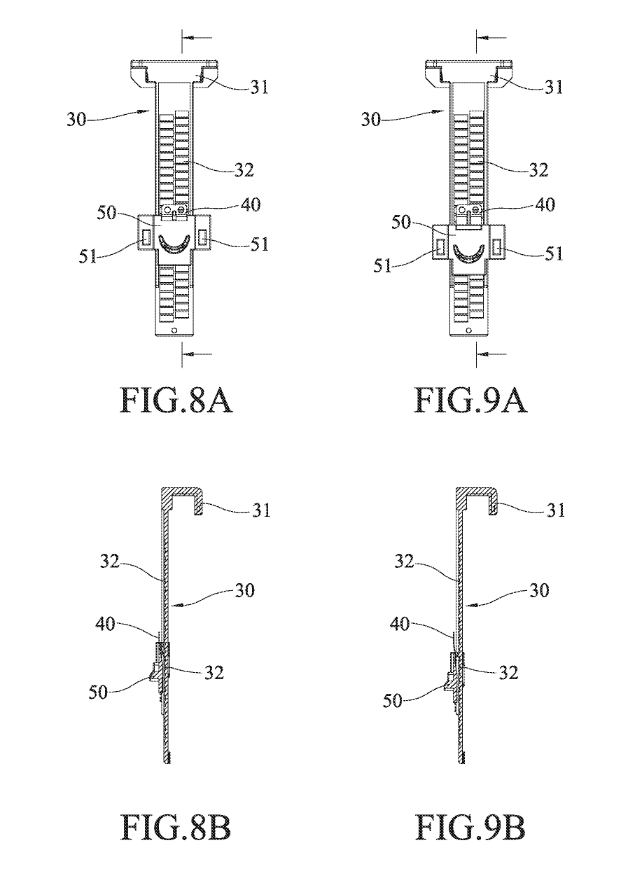

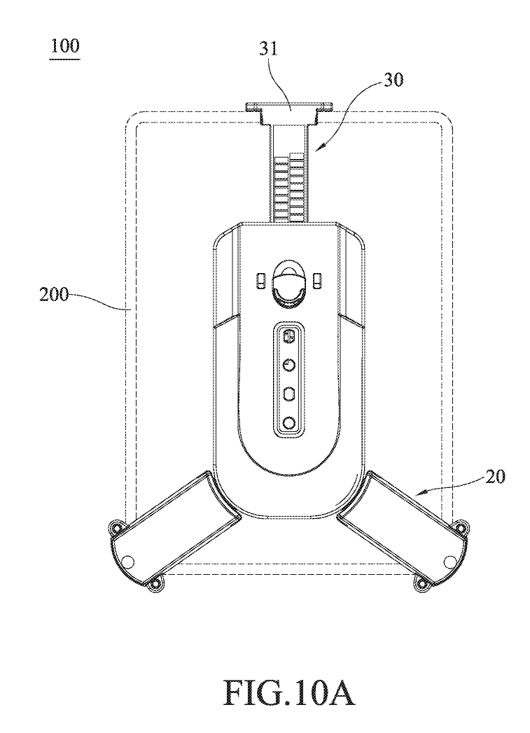

The lock rack 100 further comprises a flexible stop plate 40 and a movable drive block 50 with a fixing aperture 51, wherein the movable drive block 50 is movable toward a first position on which the fixing aperture 51 corresponds to the locking orifice 11 (as shown in FIG. 8A and 8B), and the movable drive block 50 is movable toward a second position on which the flexible stop plate 40 releases the movable press rod 30 (as shown in FIG. 9A and 9B), such that when the portable electronic device 200 is mounted on the lock rack 100, a Kensington lock (not shown) is locked on the fixing aperture 51 and the locking orifice 11 so as to position the movable press rod 30, thus locking the portable electronic device 200 on the lock rack 100.

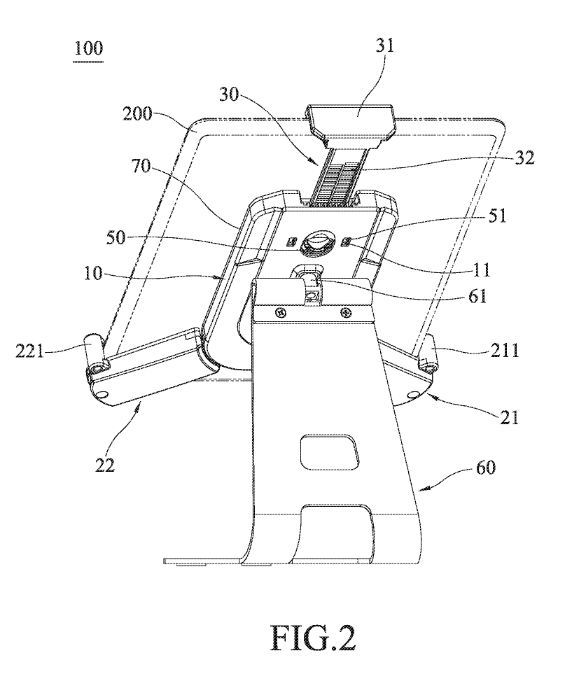

As illustrated in FIG. 2, the movable press rod 30 further includes multiple recesses 32 configured to retain with the flexible stop plate 40. The movable drive block 50 is pushed by one or multiple springs 52 to position at the first position.

With reference to FIGS. 1 and 2, lock rack 100 further comprises a bracket 60 connected with the case 10, the case 10 includes at least one connection orifice 12 configured to connect with the bracket 60. The bracket 60 includes a universal joint 61 coupled with one of the at least one connection orifice 12 so that a tilted angle of the case 10 is adjustable relative to the bracket 60 by using the universal joint 61. The bracket 60 further includes multiple positioning holes 62 configured to lock the bracket 60 on a desktop or any fasteners.

A protective pad 70 made of flexible material is attached on the case 10, the first extending fixer 21, the second extending fixer 22, and the movable press rod 30. The protective pad 70 contacts the portable electronic device's 200 surface.

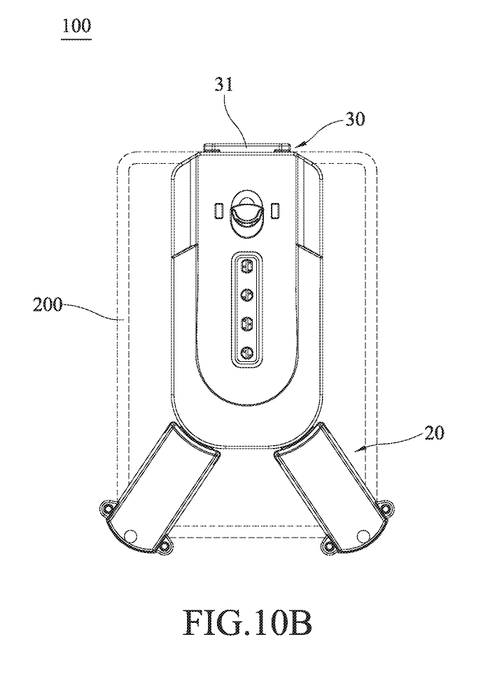

With reference to FIGS. 10A and 10B, the lock rack 100 is applicable for a variety of portable electronic devices 200 having different sizes. For example, the first corner of the lower end of the portable electronic device 200 is engaged with the first extending fixer 211, and the second corner of the lower end of the portable electronic device 200 is engaged with the second extending fixer 221, then the movable press rod 30 is movable at a distance equal to a length of the portable electronic device 200 and retains with the lower end of the portable electronic device 200.

Thereby, the lock rack 100 is applied to lock the portable electronic device and is locked on the desktop or any fasteners securely.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A lock rack comprising:
a case including a locking orifice;
a support mounting including a first extending fixer and a second extending fixer which are rotatably connected with the case and are meshed with each other, the first extending fixer having a first engagement portion for engaging with a first corner of a lower end of a portable electronic device, and a second extending fixer having a second engagement portion for engaging with a second corner of the lower end of the portable electronic device; and
a movable press rod inserted into the case and including a retainer configured to retain with an upper end of the portable electronic device.

2. The lock rack as claimed in claim 1, wherein a protective pad made of flexible material is attached on the case, the first extending fixer, the second extending fixer, and the movable press rod.

3. The lock rack as claimed in claim 1, wherein the first extending fixer has a first gear portion, and the second extending fixer has a second gear portion meshing with the first gear portion.

4. The lock rack as claimed in claim 1, wherein the first extending fixer is movable and has a first push button configured to fix a moving length of the first extending fixer, the second extending fixer is movable and has a second push button configured to fix a moving length of the second extending fixer, the first extending fixer further has a first resilient element configured to position the first push button, and the second extending fixer further has a second resilient element configured to position the second push button.

5. The lock rack as claimed in claim 1 further comprising:
a flexible stop plate arranged on the case and configured to limit a movement of the movable press rod;
a movable drive block mounted on the case and including a fixing aperture, wherein the movable drive block is movable toward a first position on which the fixing aperture corresponds to the locking orifice, and the movable drive block is movable toward a second position on which the flexible stop plate releases the movable press rod.

6. The lock rack as claimed in claim 5, wherein the movable press rod further includes multiple recesses configured to retain with the flexible stop plate.

7. The lock rack as claimed in claim 5, wherein the movable drive block is pushed by one or multiple springs to position at the first position.

8. The lock rack as claimed in claim 1 further comprising a bracket connected with the case.

9. The lock rack as claimed in claim 8, wherein the case includes at least one connection orifice configured to connect with the bracket.

10. The lock rack as claimed in claim 9, wherein the bracket includes a universal joint coupled with one of the at least one connection orifice.
